(19) United States
(12) Patent Application Publication
(10) Pub. No.: US 2025/0386143 A1
(43) Pub. Date: Dec. 18, 2025

(54) STRUCTURE FOR MAXIMIZING EFFECTIVE VIBRATING AREA IN A SPEAKER

(71) Applicant: BUJEON CO., LTD., Ansan-si (KR)

(72) Inventors: Minkoo PARK, Hwaseong-si (KR); Seungwoo CHUN, Hwaseong-si (KR); Halim KIM, Hwaseong-si (KR); Jemyeong JEON, Ansan-si (KR)

(21) Appl. No.: 19/241,350

(22) Filed: Jun. 17, 2025

(30) Foreign Application Priority Data
Jun. 18, 2024 (KR) 10-2024-0078652

(51) Int. Cl. H04R 7/12; H04R 1/02

(52) U.S. Cl. CPC H04R 7/127; H04R 1/02

(57) ABSTRACT

The present invention provides a structure maximizing an effective vibration area in a speaker. The structure includes the first adhesive portion of the edge dome of a diaphragm, and an adhesion target member having a second adhesive portion configured to be adhered to the first adhesive portion. An adhered portion is formed by adhesion between the first and second adhesive portions. The thickness from the outermost point of the structure to the point where the edge dome starts, excluding the portion where the adhered portion is formed in the edge dome, is 0.2 mm or less.

### CROSS-REFERENCE TO RELATED APPLICATION

This application claims the benefit of Korean Patent Application No. 10-2024-0078652 filed on Jun. 18, 2024, which is hereby incorporated by reference herein in its entirety.

### BACKGROUND

### 1. Technical Field

The present invention relates to a structure for maximizing an effective vibration area in a speaker.

### 2. Description of the Related Art

The effective area of a microspeaker diaphragm has significant influences on the performance, control, and sound quality of sound pressure. The diaphragm includes a center dome provided in the center and an edge dome disposed around the center dome, and generates vibration sound in response to an electric signal applied to a voice coil attached to the bottom of the diaphragm.

In conventional technology, the outermost structure of the edge dome of a diaphragm has a structure in which the outermost surface of the edge dome 10′ of a diaphragm 1′ is fabricated as a horizontally-shaped edge 12′ and the lower surface of the edge 12′ comes into contact with the top surface of a ring 2′, as shown in FIG. 5A. The length d′ from the outermost point of a driver to the starting point of the edge dome 10′ is 0.35 mm. In reality, the edge 12′ is not exposed for a portion corresponding to this length d′, so that it becomes a portion that is lost in the edge dome 10′. The lost portion is present around the overall outer circumference of the edge dome 10′ and is excluded from the effective vibration area of the diaphragm, resulting in a loss of sound pressure.

As shown in FIG. 5B, an adhesive part 13′ is integrated with the bottom surface of the edge 12′ of the edge dome 12′ to fabricate a vibration plate 1′. In this case, the bottom surface of the adhesive part 13′ is adhered to an adhesion target member 14′ such as a frame or plate, not the ring 2′. However, even in this case, the thickness of a length d′ is 0.35 mm, which cannot overcome the above-described disadvantage.

Meanwhile, when the stable fixation, durability, and adhesiveness of the diaphragm 1′ are taken into consideration, it is not desirable to reduce only the thickness of the adhesive portion, and it is reasonable to consider the relationship with other members.

As a patent document, Korean Patent Application Publication No. 2002-0004684 discloses a structure for adhering the adhesive part 125′ of an edge 120′ to the flat top surface of a frame as shown in FIG. 6, but it basically corresponds to conventional technology such as that shown in FIG. 1B.

In addition, in the conventional technology, the diaphragm is fabricated to have a plate thickness exceeding 100 μm, so that the conventional technology has a limitation in which it does not necessarily fit a TWS application.

Therefore, the present invention has been contrived to maximize the effective vibration area of a speaker by improving the adhesive portion of the edge dome of a diaphragm and its related structure while taking into consideration the disadvantages of the above-described conventional technology and preceding patent publication.

### SUMMARY

Therefore, an object of the present invention is to provide an improved speaker structure in which an effective vibration area is maximally improved.

According to an aspect of the present invention, there is provided a structure maximizing an effective vibration area in a speaker, the structure including the first adhesive portion of the edge dome of a diaphragm, and an adhesion target member having a second adhesive portion configured to be adhered to the first adhesive portion; wherein an adhered portion is formed by adhesion between the first and second adhesive portions; and wherein a thickness from the outermost point of the structure to the point where the edge dome starts, excluding the portion where the adhered portion is formed in the edge dome, is 0.2 mm or less.

The first adhesive portion may be a downwardly inclined surface extending from the point, where the semicircle of the edge dome ends when viewed from the inside of the speaker, toward an outermost point; the second adhesive portion may have a shape complementary to that of the first adhesive portion; and the angle formed between the first adhesive portion and a horizontal plane may be 30 to 90°.

The end point of the first adhesive portion may end in a manner that coincides with the outer end point of the second adhesive portion.

The adhesion target member may be a frame; the first adhesive portion of the edge dome may include a horizontal portion and a vertical portion continuously extending and vertically bent downward from the horizontal portion; the frame may also have a corresponding horizontal portion and a corresponding vertical portion; and the total height of the vertical portion of the edge dome may be 0.35 mm or more.

The adhesion target member may be a ring; the first adhesive portion of the edge dome may include a vertical portion extending upward and a horizontal portion continuously extending and bent horizontally from the vertical portion; the ring may be fabricated to have a constant thickness of 0.2 mm or less, and may be installed to extend upward beyond the overall height of the edge dome; and the vertical portion of the edge dome may be 0.35 mm or more for adhesive strength and durability.

The plate thickness of the diaphragm may be 100 μm or less.

The length of the adhered portion of the inclined surface may be 0.35 mm or more.

According to another aspect of the present invention, there is provided a structure for maximizing an effective vibration area in a speaker, the structure forming an adhered portion by means of the edge dome of a diaphragm and an adhesion target member; wherein the thickness from the outermost point of the structure to the point where the edge dome starts, excluding a portion where the adhered portion is formed in the edge dome, is 0.2 mm or less; and wherein the adhesion target member is integrated with the diaphragm along the edge of the edge dome of the diaphragm.

According to still another aspect of the present invention, there is provided a TWS speaker having the structure for maximizing an effective vibration area, wherein the maximum size of a driver including the diaphragm of the speaker is 18 mm.

The present invention has the effect of securing the stability of the vibration system by performing design to maximize the effective vibration area to the extreme and expanding the inner diameter of the coil and thus increasing the length of the coil.

The present invention has the effect of maximizing the magnetic flux density by expanding the outer diameter of the magnetic field part including the magnet and also strengthening the adhesive structure of the edge dome.

### BRIEF DESCRIPTION OF THE DRAWINGS

The above and other objects, features, and advantages of the present invention will be more clearly understood from the following detailed description taken in conjunction with the accompanying drawings, in which:

FIGS. 1A-1B is a representative diagram illustrating the concept of a structure for maximizing an effective vibration area in a speaker according to the present invention;

FIGS. 2A-2B illustrates an example of a preferred process for implementing the structure of the present invention according to FIGS. 1A-1B;

FIGS. 3A-3C illustrates another embodiment using a dummy member in the present invention;

FIGS. 4A-4D is a diagram showing another embodiment of a structure for maximizing an effective vibration area in a speaker according to the present invention;

FIGS. 5A-5B is a diagram showing the diaphragm of a conventional technology; and

FIG. 6 is a diagram showing the diaphragm of another conventional technology.

### DETAILED DESCRIPTION

The present invention may be subject to various modifications and have various embodiments. Specific embodiments will be illustrated in the accompanying drawings and described in detail in the detailed description of the invention for carrying out the invention. However, this is not intended to limit the present invention to specific embodiments, and it should be understood that the present invention encompasses all modifications, equivalents, and substitutes included in the spirit and technical scope of the present invention.

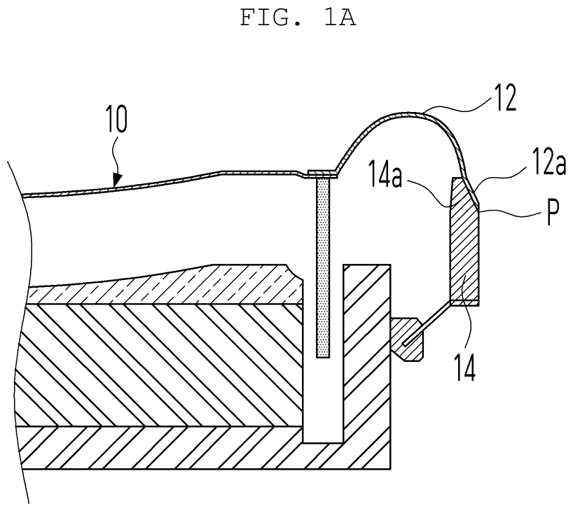

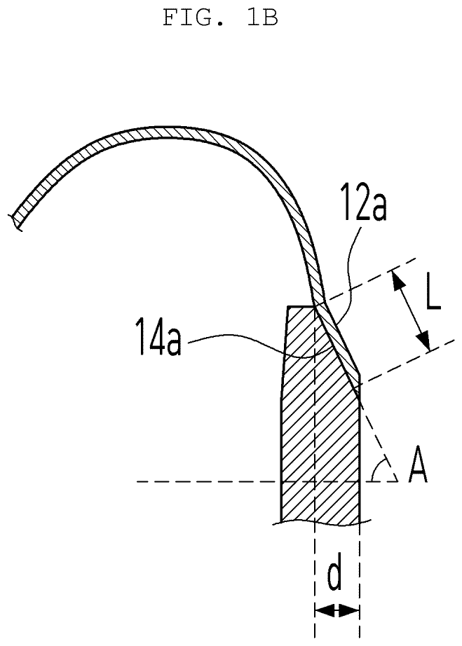

FIGS. 1A-1B is a representative diagram illustrating the concept of a structure for maximizing an effective vibration area in a speaker according to the present invention. In the present invention, the first adhesive portion 12a of the edge dome 12 of a diaphragm 10 is adhered to an adhesion target member 14. In this case, the term “adhesion target member” should be interpreted as having a broad concept including a member, such as a ring, a frame, or a plate, to which the bottom surface of the edge dome 12 is adhered, and is not particularly limited. The first adhesive portion 12a is a portion that extends from the point, where the semicircular arc of the edge dome 12 ends when viewed from the inside, toward the outermost point, and is formed as an inclined surface that is inclined downward in the outward direction, as shown in the drawing. The inclined surface is generally a flat surface, but does not necessarily mean a straight line. In response to this, the second adhesive portion 14a of the adhesion target member 14 is also formed in a shape complementary to that of the first adhesive portion 12a, i.e., as an inclined surface that inclines downward in the outward direction. It is preferable that the angle “A” formed between the first adhesive portion 12a and the horizontal plane be 30 to 90°.

The first adhesive portion 12a and the second adhesive portion 14a are adhered over the overall inclined surfaces, and form an adhered portion. The end point of the first adhesive portion 12a almost coincides with the outer end point of the second adhesive portion 14a, and ends at point P.

As long as the adhesion target member 14 includes the second adhesive portion 14a which is an inclined surface, other portions of the adhesion target member 14 may be formed in other suitable shapes such as a horizontal or vertical shape.

In the present invention, the thickness d from the outermost point of a driver to the point where a dome shape, i.e., a semicircular arc, starts, which is the point where the edge dome 12 starts, is 0.2 mm or less. In this case, the total length L along the inclined surface of the adhered portion is longer than the thickness d. In the case of 30°, it is “2/d”, and in the case of 60°, it is “2d.” Accordingly, the actual length of the adhered portion may be adjusted by adjusting the angle A. When d=0.2 mm, the length of the adhered portion is approximately 0.348 mm in the case of 30°, and 0.4 mm in the case of 60°. Accordingly, the total length or more of the adhered portion of the conventional technology is secured to maintain durability and adhesiveness, and also the effective vibration area is 0.35 mm-0.2 mm=0.15 mm or more in the radius compared to the conventional technology to obtain a ring-shaped frame more.

The size of the driver of the speaker including the diaphragm 10 of the present invention is up to 18 mm or less, which is ultra-small.

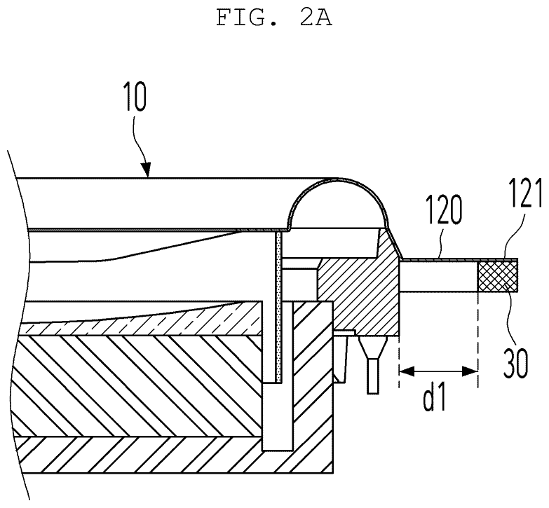

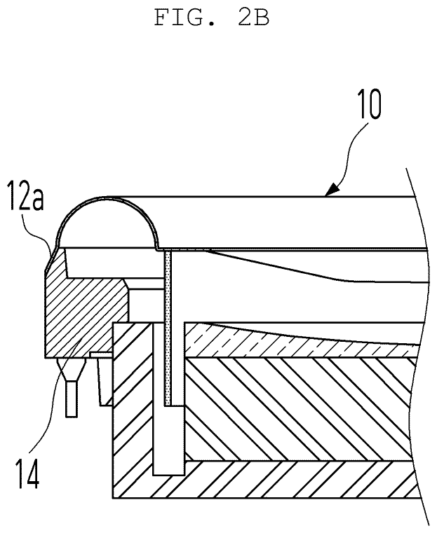

FIGS. 2A-2B illustrates an example of a preferred process for implementing the structure of the present invention according to FIGS. 1A-1B. Recently, due to the softening and thinning of the material of the diaphragm 10, it is not easy to directly form the thin first adhesive portion 12a such as that shown in FIGS. 1A-1B. Accordingly, in the process of the present invention, as shown in FIGS. 2A, the diaphragm 10 is fabricated to include a dummy edge 120 that extends horizontally outward from the end of the first adhesive portion 12a of the edge dome 12. A dummy ring 30 that supports the dummy edge 120 from below is attached to the outer portion 121 of the dummy edge 120. It is preferable that the distance d1 from the point P to the inner surface of the dummy ring 30 be 3 mm or less at most.

Thereafter, in the process, the dummy edge 120 and the dummy ring 30 are cut with an appropriate cutter or cutting tool. Then, as shown in FIG. 2B, a structure in which the length of the adhered portion is 0.35 mm or more may be completed. The dummy edge 120 and the dummy ring 30 are intermediate members that are used to leave a thin adhered portion. Due to these, the model production of the vibration plate 10 is easy and the molding thereof is simple, and furthermore an adhered portion having a thin thickness may be implemented.

In the above process, the plate thickness of the diaphragm 10 is particularly suitable for designing a thin film diaphragm of 100 μm or less when the thin thickness of the adhered portion and the use of the dummy member are taken into consideration.

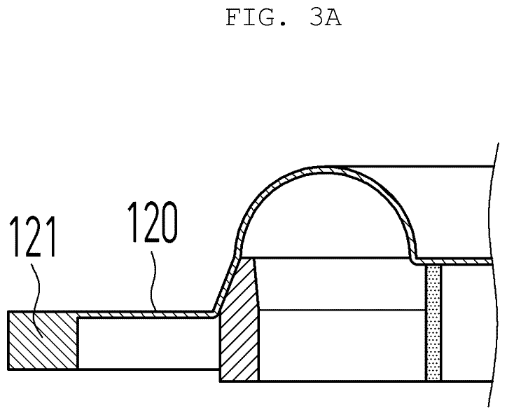

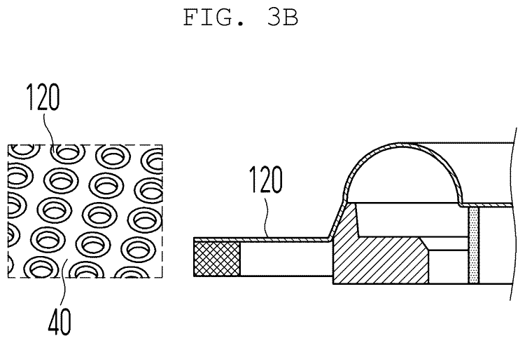

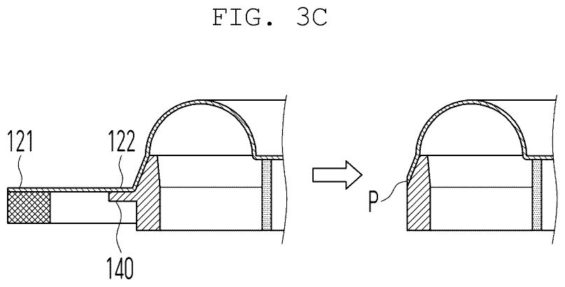

FIGS. 3A-3C illustrates another embodiment using a dummy member in the present invention.

FIG. 3A shows the outer portion 121 of the dummy edge 120 formed into a thick ring shape. The outer portion 121 has the same function as the dummy ring 30 of FIG. 2A. In this case, the person hours for separately attaching the dummy ring 30 may be reduced.

FIG. 3B is a diagram showing the use of a carrier 40 accommodating a plurality of arranged diaphragms as the dummy edge 120 during a process of manufacturing diaphragms.

FIG. 3C shows a wing portion 140 formed separately from a point near the lowermost point of the second adhesive portion 14a of the adhesion target member 14 toward the outside to support a portion of an inner surface 122 that extends horizontally from the point of the dummy edge 120 where the first adhesive portion 12a ends. In a cutting process, both the dummy edge 120 and the wing portion 140 are cut at the point P. In this case, in a cutting process, the end portion may be prevented from being deformed or damaged during the cutting process because the thickness of the first adhesive portion 12a is thin.

Furthermore, the structure for maximizing a effective vibration area in a speaker according to the present invention may be varied in various manners based on the type and shape of the adhesion target member 14 based on FIGS. 1A-1B.

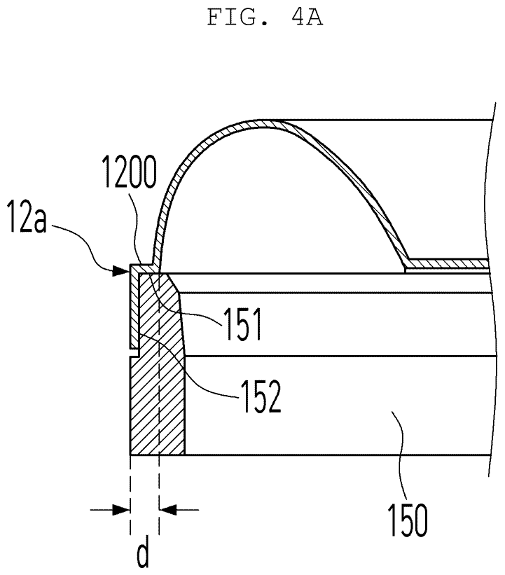

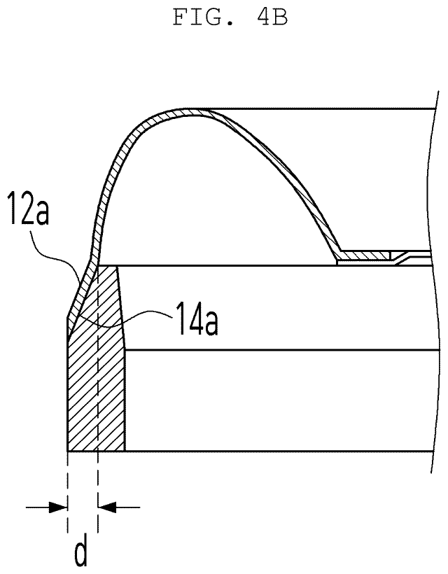

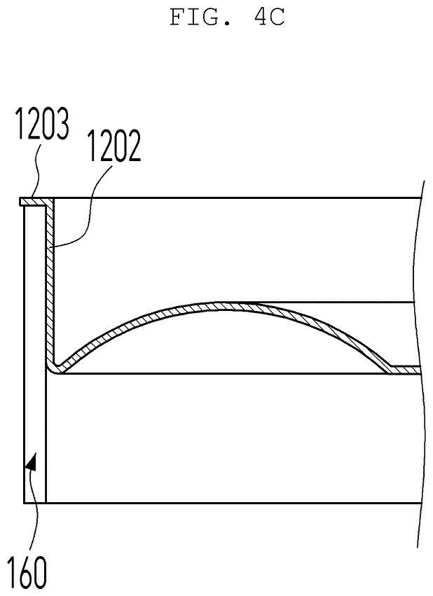

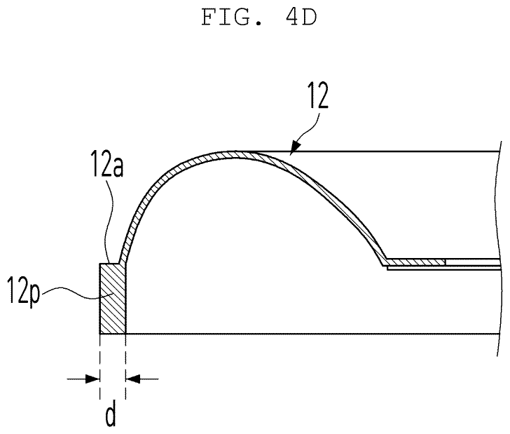

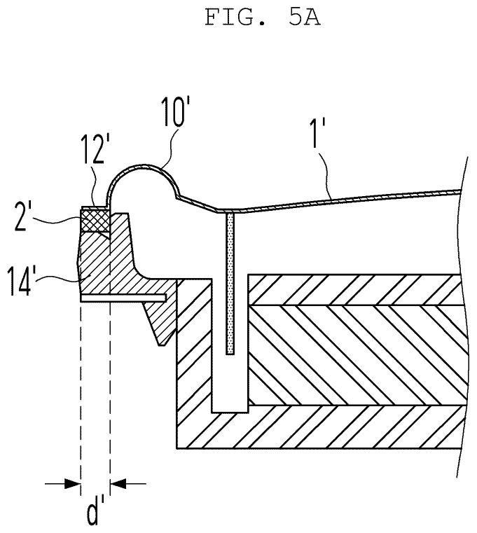

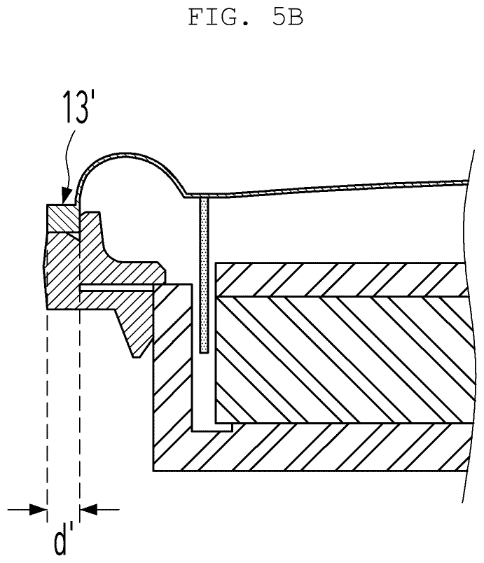

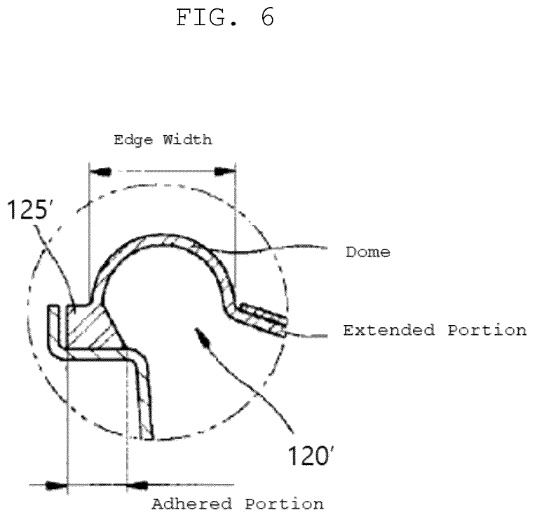

FIG. 4A is a case where the adhesion target member 14 is a frame 150. The first adhered portion 12a of the edge dome 12 includes a horizontal portion 1200 and a vertical portion 1201 continuously extending and vertically bent downward from the horizontal portion 1200. Accordingly, a corresponding horizontal portion 151 and a corresponding vertical portion 152 are formed in the frame 150. The horizontal portion 1200 and the horizontal portion 151 are adhered to each other, and the vertical portion 1201 and the vertical portion 152 are adhered to each other. The distance d from the outermost point of the driver to the starting position of the edge dome 12 is 0.2 mm or less. The total height of the vertical portion 1201 is 0.35 mm or more, which has the advantage of maintaining the adhesive strength while providing the distance d. As long as the adhesive strength can be maintained, the total length of the vertical portion 1201 does not necessarily have to be the same as that of the vertical portion 152, and a gap may be provided as illustrated in the drawing.

The structure of FIG. 4B is similar to that of FIGS. 1A-1B notwithstanding that the adhesion target member 14 is the frame 150 as shown in FIG. 4A. However, the end of the first adhesive portion 12a formed as an inclined surface does not extend to the end of the second adhesive portion 14a, and the actual length of the adhered portion is somewhat shorter than that of FIGS. 1A-1B. However, as long as the length of the adhered portion is maintained at 0.35 mm or more, a gap may be provided as shown in the drawing. In the present invention, the most important condition is that the thickness d, which is the distance from the outermost point P of the driver to the starting point of the edge dome 12, is 0.2 mm or less.

FIG. 4C shows a case where the adhesion target member 14 is a ring 160, and the first adhesive portion 12a of the edge dome 12 includes a vertical portion 1202 extending upward and a horizontal portion 1203 continuously extending and bent horizontally from the vertical portion 1202. The ring 160 is a cylinder having a constant thickness of 0.2 mm or less as shown in the drawing, and it is sufficient to fabricate the ring 160 so that it extends beyond the overall height of the edge dome 12, and there is no need to form separate horizontal and vertical portions. The vertical portion 1202 and the horizontal portion 1203 naturally come into contact with each of the protruding portions of the ring 160. The overall height of the vertical portion 1202 is set to 0.35 mm or more for adhesive strength and durability.

In contrast to FIG. 4C, various modifications may be made possible, as in a case where the first adhesive portion 12a of the edge dome 12 is composed of a vertical portion extending downward from a dome and a horizontal portion extending outward from the vertical portion and a plate supporting the vertical portion and the horizontal portion from below is provided.

FIG. 4D shows a structure in which the first adhesive part 12a of an edge dome 12 is integrated with an adhesive portion 12p, and an effect that is the same as that of FIG. 4A may be expected from FIG. 4D.

In order to verify the effect of the structure maximizing an effective vibration area in a speaker according to the present invention, the inventors compared embodiments of the present invention in which the distances d from the outermost point of the driver to the point where the edge dome 12 started were 0.2 mm and 0.1 mm, respectively, with conventional technologies in which the distances d were 0.35 mm and 0.4 mm, respectively, in terms of the area expansion ratio, magnetic flux density increase, coil length increase ratio, and SPL (sound pressure level). The results are as follows. These are based on a Φ11 mm speaker.

### Effective Area Expansion Ratio

TABLE 1

| | Effective Vibration | Increase/Decrease Rate |
|---|---|---|
| Distance (d) | Area (mm²) | (%) |
| 0.1 mm | 60.9 | — |
| 0.2 mm | 60.4 | — |
| 0.35 mm | 58.8 | −3.4/−2.6 |
| 0.4 mm | 58.2 | −4.4/−3.6 |

### Magnetic Flux Density Increase

TABLE 2

| | Magnetic Flux Density | Increase/Decrease Rate |
|---|---|---|
| Distance (d) | (mT) | (%) |
| 0.1 mm | 561.2 | — |
| 0.2 mm | 557.7 | — |
| 0.35 mm | 546.4 | −2.6/−2.0 |
| 0.4 mm | 542.3 | −3.4/−2.7 |

### Coil Length Increase Ratio

TABLE 3

| | | Increase/Decrease Rate |
|---|---|---|
| Distance (d) | Coil length (m) | (%) |
| 0.1 mm | 1.89 | — |
| 0.2 mm | 1.83 | — |
| 0.35 mm | 1.74 | −8/−5 |
| 0.4 mm | 1.71 | −10/−7 |

### Sound Pressure

TABLE 4

| | | Increase/Decrease |
|---|---|---|
| Distance (d) | dE | Amount (dB) |
| 0.1 mm | 155.6739 | — |
| 0.2 mm | 155.2669 | — |
| 0.35 mm | 154.4184 | −1.26/−0.85 |
| 0.4 mm | 154.1138 | −1.56/−1.15 |

(In the increase/decrease rates and increase/decrease amount, the left side is based on 0.15 mm and the right side is based on 0.2 mm)

According to the present invention, when the distance d is 0.2 mm or less, it was confirmed that the present invention was superior to the conventional technology in terms of the expansion in the effective area of the diaphragm, the increase in magnetic flux density, the increase in coil length, and the effect of sound pressure.

Although exemplary embodiments of the present invention have been described above, various changes and modifications may be made to the present invention, and it is obvious that the scope of the rights of the present invention extends to the scope that is the same as or equivalent to that of the claims, which will be described below.

What is claimed is:

1. A structure maximizing an effective vibration area in a speaker, the structure comprising a first adhesive portion of an edge dome of a diaphragm, and an adhesion target member having a second adhesive portion configured to be adhered to the first adhesive portion;
wherein an adhered portion is formed by adhesion between the first and second adhesive portions; and
wherein a thickness from an outermost point of the structure to a point where the edge dome starts, excluding a portion where the adhered portion is formed in the edge dome, is 0.2 mm or less.

2. The structure of claim 1, wherein:
the first adhesive portion is a downwardly inclined surface extending from a point, where a semicircle of the edge dome ends when viewed from an inside of the speaker, toward an outermost point;
the second adhesive portion has a shape complementary to that of the first adhesive portion; and
an angle formed between the first adhesive portion and a horizontal plane is 30 to 90°.

3. The structure of claim 2, wherein an end point of the first adhesive portion ends in a manner that coincides with an outer end point of the second adhesive portion.

4. The structure of claim 1, wherein:
the adhesion target member is a frame;
the first adhesive portion of the edge dome includes a horizontal portion and a vertical portion continuously extending and vertically bent downward from the horizontal portion;
the frame also has a corresponding horizontal portion and a corresponding vertical portion; and
a total height of the vertical portion of the edge dome is 0.35 mm or more.

5. The structure of claim 1, wherein:
the adhesion target member is a ring;
the first adhesive portion of the edge dome includes a vertical portion extending upward and a horizontal portion continuously extending and bent horizontally from the vertical portion;
the ring is fabricated to have a constant thickness of 0.2 mm or less, and is installed to extend upward beyond an overall height of the edge dome; and
the vertical portion of the edge dome is 0.35 mm or more for adhesive strength and durability.

6. The structure of claim 1, wherein a plate thickness of the diaphragm is 100 μm or less.

7. The structure of claim 2, wherein a length of the adhered portion of the inclined surface is 0.35 mm or more.

8. A structure for maximizing an effective vibration area in a speaker, the structure forming an adhered portion by means of an edge dome of a diaphragm and an adhesion target member;
wherein a thickness from an outermost point of the structure to a point where the edge dome starts, excluding a portion where the adhered portion is formed in the edge dome, is 0.2 mm or less; and
wherein the adhesion target member is integrated with the diaphragm along an edge of the edge dome of the diaphragm.

9. A TWS speaker having the structure for maximizing an effective vibration area of claim 1, wherein a maximum size of a driver including the diaphragm of the speaker is 18 mm.

10. A TWS speaker having the structure for maximizing an effective vibration area of claim 2, wherein a maximum size of a driver including the diaphragm of the speaker is 18 mm.

11. A TWS speaker having the structure for maximizing an effective vibration area of any one of claim 3, wherein a maximum size of a driver including the diaphragm of the speaker is 18 mm.

12. A TWS speaker having the structure for maximizing an effective vibration area of claim 4, wherein a maximum size of a driver including the diaphragm of the speaker is 18 mm.

13. A TWS speaker having the structure for maximizing an effective vibration area of claim 5, wherein a maximum size of a driver including the diaphragm of the speaker is 18 mm.

14. A TWS speaker having the structure for maximizing an effective vibration area of claim 6, wherein a maximum size of a driver including the diaphragm of the speaker is 18 mm.

15. A TWS speaker having the structure for maximizing an effective vibration area of claim 7, wherein a maximum size of a driver including the diaphragm of the speaker is 18 mm.

16. A TWS speaker having the structure for maximizing an effective vibration area of claim 8, wherein a maximum size of a driver including the diaphragm of the speaker is 18 mm.
